(19) United States
(12) Patent Application Publication
(10) Pub. No.: US 2015/0260344 A1
(43) Pub. Date: Sep. 17, 2015

(54) PROTECTIVE CAP WITH PIVOTING ATTACHMENT SYSTEM FOR GAS CYLINDER

(71) Applicant: L'Air Liquide, Société Anonyme pour l'Etude et l'Exploitation des Procédés Georges Claude, Paris (FR)

(72) Inventors: Antoine FRENAL, Ezanville (FR); Vincent Graviere, Ivry sur Seine (FR); Renaud Ligonesche, Herblay (FR); Chiara Tarantello, Puteaux (FR); Adrien Trevisan, Neuilly sur Seine (FR); Samuel Vignerol, Louvres (FR)

(21) Appl. No.: 14/642,018

(22) Filed: Mar. 9, 2015

(30) Foreign Application Priority Data
Mar. 12, 2014 (FR) 1452039

(51) Int. Cl. F17C 13/06; F17C 1/00

(52) U.S. Cl. CPC F17C 13/06; F17C 1/00

(57) ABSTRACT

The invention relates to a protective cap for gas container, comprising a cap body forming a protective shell delimiting an internal volume designed to accommodate all or part of the valve-assembly, and an attachment device able to pivot between several angular positions, comprising a rest position in which the attachment device is fully folded, and an attachment position in which the attachment device is completely unfolded. The attachment device comprises a three-dimensional structure comprising two arms each bearing a cutout for fixing to a support, the said three-dimensional structure comprising an interior face shaped to conform to the exterior profile of the body of the cap when the attachment device is in the rest position.

### CROSS REFERENCE TO RELATED APPLICATIONS

This application claims the benefit of priority under 35 U.S.C. §119 (a) and (b) to French Patent Application No. 1452039 filed Mar. 12, 2014, the entire contents of which are incorporated herein by reference.

### BACKGROUND

The present invention relates to a protective cap, also referred to as a bonnet, for gas, particularly medical gas, cylinders, which is equipped with a device for attachment to beds, stretchers, wheelchairs or the like, which conforms to the exterior contours of the cap body when folded into its rest position.

Industrial and medical gases are commonly packaged into gas containers, typically gas cylinders, equipped with a valve-assembly, with or without inbuilt pressure regulator, namely a simple valve of the open/closed type or a valve with an inbuilt regulator, also referred to as a regulating valve, that allows control over the flow rate and pressure of the gas delivered.

In order to protect this valve-assembly, it is common practice to arrange at the neck of the gas cylinder, and around the said valve-assembly, a protective cap that forms a protective shell around the said valve-assembly. Such a cap is commonly referred to as a “bonnet”.

Moreover, in order to allow the cylinder/bonnet/valve assembly to be attached to a support, such as a bar of a hospital bed, a stretcher, a rung or attachment support of an emergency vehicle, for example an emergency ambulance service vehicle or the like, it is commonplace for a fixed attachment system to be formed on the bonnet.

In fact, there are two types of attachment system, fixed ones and mobile ones.

By way of example of a fixed attachment system, mention may be made of cutouts, hooks or the like formed borne by the cap, either at the time of manufacture of the cap body itself and which form an integral part thereof, or which are fixed to the cap body after the fact.

By way of example of a mobile attachment system, mention may be made of supports capable of pivoting or translational movement which can be fixed to the rear face or to a lateral face of the cap.

Caps for gas cylinders with a fixed or mobile attachment system are described by documents EP-A-629812, DE-A-10057469, US-A-2004/020793 and EP-A-2586481.

However, these various existing caps and attachment systems have disadvantages.

Thus, many attachment systems extend beyond the body of the cylinder, even when folded into their rest position, and this leads to an increase in the significant size of the cylinder/cap assembly.

Now, increasing the size of the assembly gives rise, as can be readily understood, to problems regarding the storage of the cylinders thus equipped, particularly when stowing them in the racks or other baskets used for transporting them en masse.

In addition, the fact that many pivoting attachment systems protrude beyond the overall diameter of the cylinder, even when folded, is a source of accidents for users whose clothing for example may inadvertently catch on the system and cause the cylinder to fall to the floor, with the risk of injury to people nearby.

Thus, document EP-A-2586481 teaches a pivoting attachment system for a gas cylinder bonnet. This system is formed of two pivoting arms which are joined together by a rigid rod. In the folded position, the rod butts against the body of the bonnet remaining tangential thereto, while the two arms position themselves one on either side of the top of the body of the cylinder. Such a system therefore exhibits the abovementioned disadvantages.

Others have complicated designs and/or are somewhat impractical to handle.

There is also a cap that has a special housing in which a pivoting arm can be inserted. Although that makes it possible to prevent the arm from protruding beyond the body of the cap, when folded, it also has the major disadvantage of making the interior parts of the cap and of the attachment device more complicated to clean and of generating an inevitable buildup of dust and other dirt over time in these regions of the cap, namely of giving rise to a state of cleanliness that is somewhat incompatible with use in a hospital environment. Furthermore, this pivoting arm is not necessarily easy to handle for the user whose fingers may become trapped when deploying it and hooking the assembly onto a support, such as a bar of a hospital bed.

In the light of that, the problem that arises is that of proposing a protective cap or bonnet for a gas cylinder that comprises an improved attachment device that does not have the abovementioned disadvantages.

### SUMMARY

The solution of the invention is a protective cap or “bonnet” for a gas container, particularly for a gas cylinder, equipped with a valve-assembly, with or without inbuilt regulator, comprising:
a cap body forming a protective shell delimiting an internal volume designed to accommodate all or part of the valve-assembly, and
an attachment device able to pivot between several angular positions, comprising:
   a rest position in which the attachment device is fully folded, namely in contact or near contact with the body of the cap, and
   an attachment position in which the attachment device is completely unfolded, namely completely deployed so as to allow the cap to be hooked on a support such as a bar of a bed or the like,
      characterized in that the attachment device comprises a three-dimensional structure comprising two arms each bearing a cutout for fixing to a support, the said three-dimensional structure comprising an interior face shaped to conform to the exterior profile of the body of the cap when the attachment device is in the rest position, namely it is completely folded and positioned around the cap.

Depending on circumstance, the protective cap according to the invention may comprise one or more of the following technical features:
the attachment device is fixed pivotably about an axis AA situated on the rear face of the body of the cap.
the rear face and/or the lateral faces of the body of the cap is/are shaped to have an exterior profile that complements the interior face of the three-dimensional structure.
the rear face and/or the lateral faces of the body of the cap have at least one impression made in the external shell of the body, in which impression at least part of the three-dimensional structure is housed conforming to the exterior profile of the said at least one impression.
the three-dimensional structure comprises at least one curved interior face.
the three-dimensional structure has a curved overall shape.
it comprises a locking system allowing the attachment device to be locked and kept in the rest position.
the attachment device pivots between the rest position and the attachment position through an angle (α) less than 180°, typically of between 90° and 170° , preferably by at least 110°.
it comprises at least one support upright secured to the cap body and bearing a carry handle.
the body of the cap and the three-dimensional structure are formed of polymer material. Typically, the polymer-type material is a plastics material such as PVC, PE, PET, PP, PMMA, PU, PA, etc.
the two arms are connected to one another by at least one connecting element; for preference the two arms and the said at least one connecting element are formed as a single piece, notably by moulding.
it comprises a locking system allowing the attachment device to be locked and kept in the rest position.

Furthermore, the invention also relates to a gas container equipped with a valve-assembly with or without inbuilt regulator, characterized in that it comprises a protective cap according to the invention arranged around at least part of the said valve-assembly.

According to circumstance, the gas container of the invention may comprise one or more of the following technical features:
it is chosen from gas cylinders.
it is a gas cylinder with a size of between 10 and 150 cm.
it is a gas cylinder containing 0.5 to 20 litres (water-equivalent capacity).
it is a gas cylinder with a hollow cylindrical body.
it is a gas cylinder comprising a neck bearing a gas outlet orifice.
it is a gas cylinder containing a gas or gaseous mixture chosen from oxygen, air, an N₂O/O₂ mixture, a He/O₂ mixture, an NO/nitrogen mixture or any other gas or gaseous mixture.
the valve-assembly is of the inbuilt regulator type, namely a regulating valve.
the cylinder is made of steel, of an aluminium alloy or of a composite material.
the cylinder contains a gas at a pressure ranging up to around 350 bar.

The invention also relates to a use of a gas container according to the invention to distribute a gas or gaseous mixture, particularly a gas or gaseous mixture is chosen from oxygen, air, N₂O/O₂, He/O₂ and NO/nitrogen.

### BRIEF DESCRIPTION OF THE DRAWINGS

The invention will now be better understood by virtue of the following detailed description, given by way of nonlimiting illustration, with reference to the attached figures among which:

FIG. 1 depicts a view of the front face of a protective cap according to the invention fitted to a gas cylinder,

FIG. 2 depicts a view of the rear face of the cap of FIG. 1,

FIG. 3 is a ¾ rear view of the cap of FIG. 1, and

FIG. 4 depicts an assembly formed of a gas cylinder equipped with the cap of FIG. 1 in a position in which it is lying down on a surface.

### DESCRIPTION OF PREFERRED EMBODIMENTS

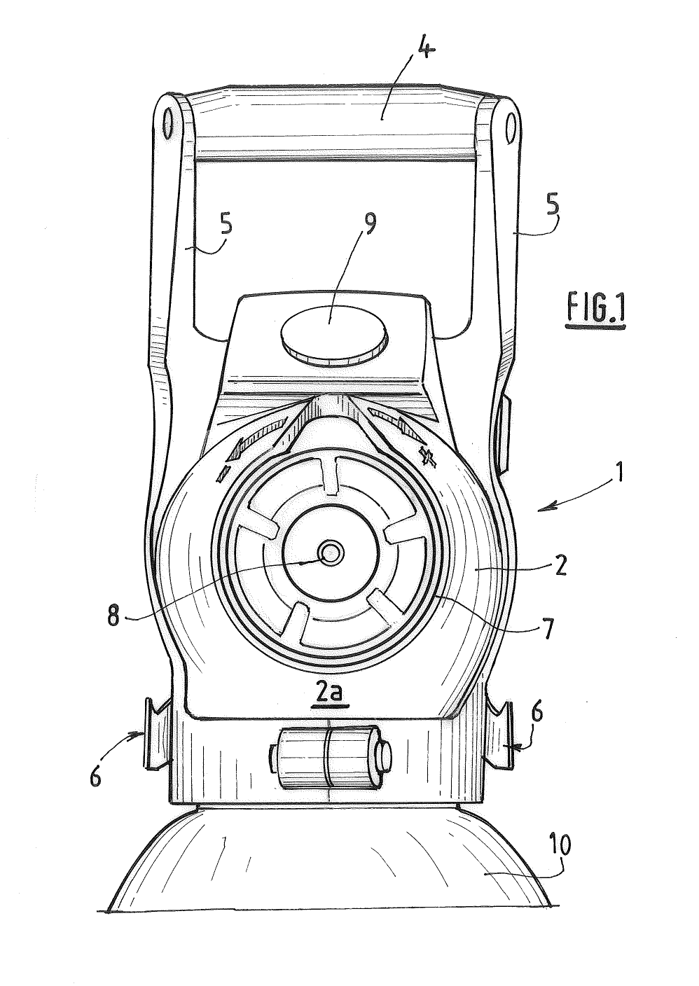

FIGS. 1 to 4 depict one embodiment of a rigid protective cap 1, commonly referred to as a “bonnet”, arranged around a valve-assembly, namely a valve with or without an inbuilt regulator, itself fixed to the neck of a gas cylinder 10.

The gas cylinder 10 typically has a size of between 10 and 150 cm, and a capacity of 0.5 to 20 litres (in water-equivalent).

The protective cap 1 serves to protect the valve-assembly against knocks, whether the said valve-assembly is of the type with inbuilt regulator or regulating valve type, or of the type without an inbuilt regulator.

To do so, the protective cap 1 comprises a cap body 2 forming a protective shell around an internal volume sized to accommodate the valve-assembly, a carry handle 4 designed to be held by hand by an operator, the said carry handle 4 being formed of a rigid material and borne by one or more support uprights 5 mechanically connecting the cap body 2 to the carry handle 4, namely that the support upright or uprights 5 are secured to the carry handle 4 in such a way as to allow a user easily to carry the bonnet/valve/cylinder assembly around.

The body 2 of the cap 1 is typically made of a material of the polymer type and/or of metal, preferably of a plastics material such as PVC, PE, PET, PP, PMMA, PU, PA, etc. Likewise, the support uprights 5 may be formed of a plastics material like the body of the cap 1, but may also be formed of aluminium alloy or any other metallic material.

The protective cap 1 also has openings providing access to the valve-assembly situated in the internal volume of the body 2 of the cap 1, particularly to the connectors, rotary handwheel, etc.

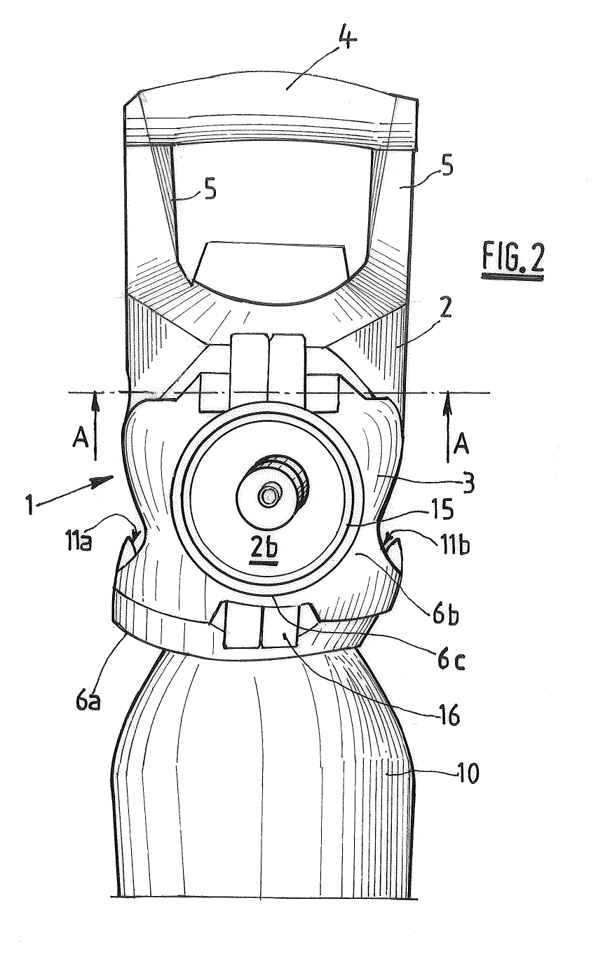

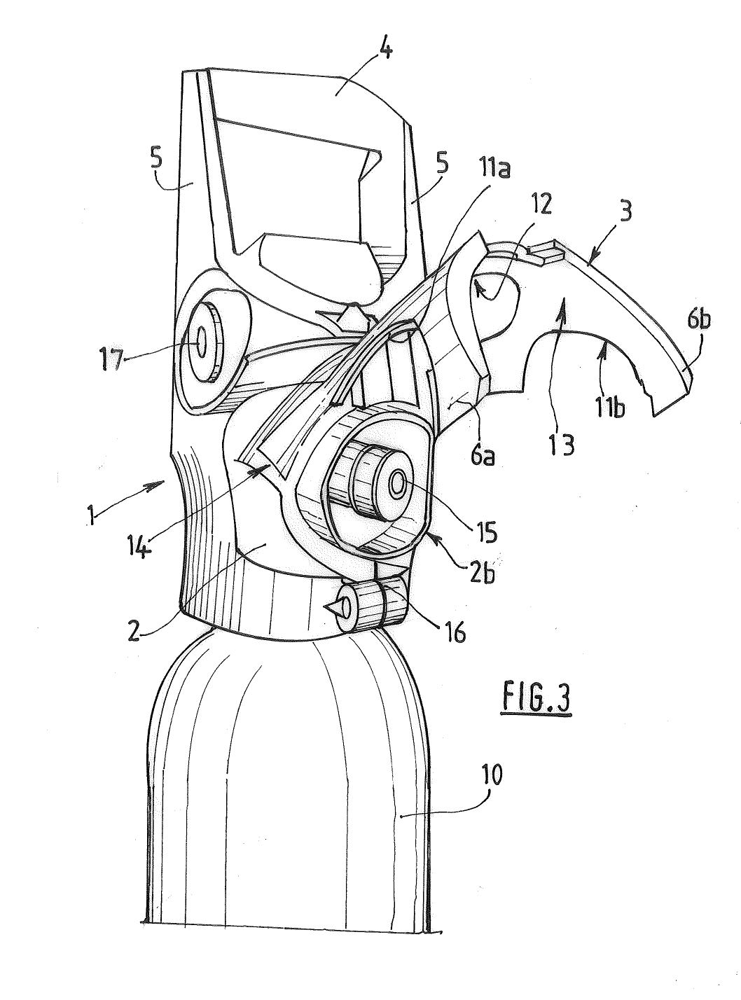

Specifically, the valve-assembly, typically a valve of the regulating valve type, comprises, as illustrated in FIG. 3, a rotary handwheel 7, situated on the front face 2a, that a user can manipulate in order to control the flow rate of gas, a gas outlet connector 8 for withdrawing the gas stored in the cylinder 10, a pressure gauge 9 for monitoring the pressure of the gas, a filling connector 15 (FIGS. 2 and 3) situated on the rear face 2b used to introduce gas into the cylinder 10 when the cylinder is empty, and a connector for delivering pressurized gas 17.

The protective cap 1 is assembled and fixed around the valve-assembly borne by the gas cylinder 10, by screwing using fixing elements, namely screws or the like.

In order to allow the cylinder/valve-assembly/cap assembly to be attached or secured to a support, such as a bar of a hospital bed or of a stretcher, the protective cap 1 may, on the side of its rear face 2b, comprise an attachment device 3 able to pivot about an axis AA between a fully folded “rest” position, namely the position adopted by the attachment device 3 when it is stored and in contact or near-contact with the body 2 of the cap 1 and a fully unfolded “attachment” position, namely the position adopted by the attachment device 3 when completely deployed, and can be hooked onto a support, such as a bar of a bed or the like.

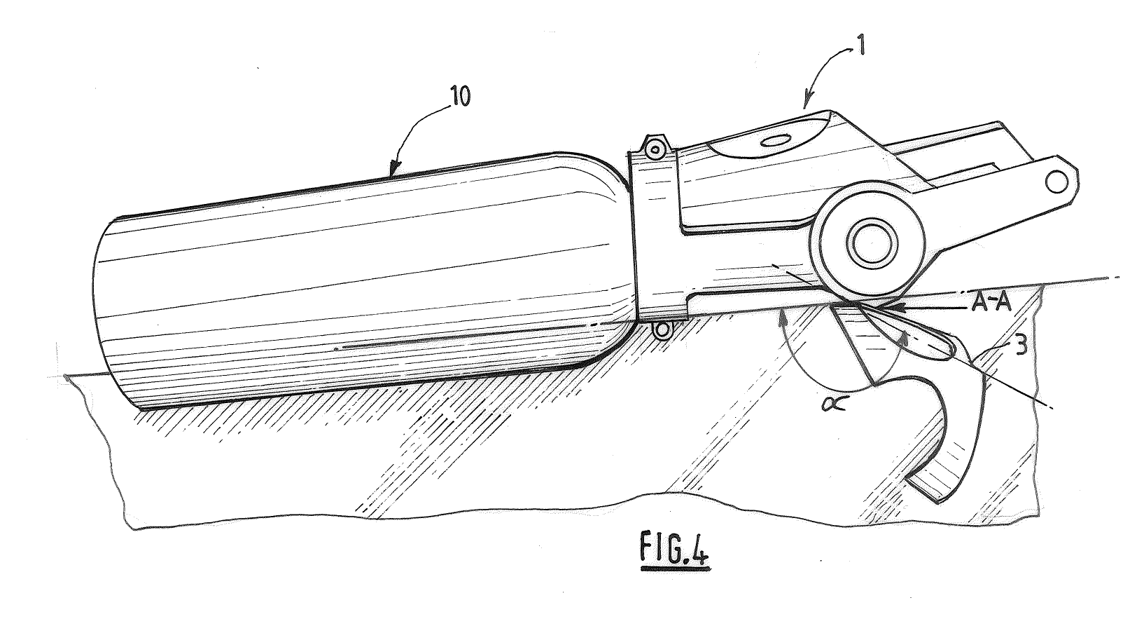

Thus, FIG. 2 shows the attachment device 3 in the rest position, namely folded, while FIGS. 3 and 4 show the attachment device 3 in the attachment position, namely completely unfolded.

These two positions therefore constitute the extreme angular positions that the attachment device 3 can adopt when pivoting about the axis AA.

Typically, the angle α of pivoting between these two extreme angular positions is less than or equal to 170° and greater than 0°, preferably greater than 90°, for example an angle of the order of 150°.

In order to resolve some of the problems presented by the known attachment devices, in the context of the present invention efforts are made to ensure perfect integration of the attachment device 3 around the body 2 of the protective cap 1.

To do this, the attachment device 3 according to the invention forms a curved three-dimensional structure 3, 6a, 6b, 11a, 11b that conforms to the contours of the body 2 of the cap when the attachment device 3 is in the rest position, namely when it is folded as illustrated in FIG. 2.

More specifically, the curved three-dimensional structure 3, 6a, 6b, 11a, 11b comprises two arms 6a, 6b, namely a right-hand arm 6a and a left-hand arm 6b, which sandwich the cap body 2 when the attachment device 3 is in the rest position.

Each of the arms 6a, 6b bears a fixing cutout 11a, 11b used for hooking the assembly on a support, such as a bar of a hospital bed or the like. Each fixing cutout 11a, 11b has a bowed shape, for example is shaped as an arc of a circle, so as to conform as well as possible to the shape of a tubular bar of a bed, a stretcher, a wheelchair or the like.

In other words, the fixing cutouts 11a, 11b of the arms 6a, 6b are shaped and sized to allow a gas container equipped with a cap according to the invention to be secured to a bar of a hospital bed or the like, namely to a tubular structure.

The three-dimensional structure 3, 6a, 6b, 11a, 11b for its part comprises an interior face 13 shaped to conform to the exterior profile 14, namely the external surface or contour, of the body 2 of the cap 1 so as to minimize the overall size of the cap 1 when the attachment device 3 is folded as in FIG. 2.

In general according to the invention the inner face 13 of the three-dimensional structure, namely the surface or wall 13 of the three-dimensional structure 3, 6a, 6b, 11a, 11b facing the cap, particularly that of the two arms 6a, 6b, is shaped to conform to the external profile or shape 14 of the body 2 of the cap 1 so as to minimize the overall size of the three-dimensional structure 3, 6a, 6b, 11a, 11b when folded and thus avoid all or some of the disadvantages of the caps of the prior art.

Thus, as visible in FIG. 3, the face 13 perfectly conforms to the exterior contour of the rear face 2b of the cap 1 by fitting into the impression 14 formed in the body 2 of the cap 1, which impression 14 has a shape that complements that of the three-dimensional structure 3, 6a, 6b, 11a, 11b when the three-dimensional structure 3, 6a, 6b, 11a, 11b is in its rest or completely folded position as shown in FIG. 2.

In other words, in order to increase the integration of the three-dimensional structure 3, 6a, 6b, 11a, 11b into the body 2 of the cap 1, provision is made for at least one impression 14 to be formed on the contour of the body 2 of the cap 1, this impression being specific and adapted and shaped to accept all or part of the three-dimensional structure 3, 6a, 6b, 11a, 11b which will then become lodged therein in the folded, namely the rest, position.

Thus, when the three-dimensional structure 3, 6a, 6b, 11a, 11b is folded it projects externally little if at all and does not increase the overall size of the cap 1.

The three-dimensional structure 3, 6a, 6b, 11a, 11b, aside from providing attachment to a support such as a bar of a hospital bed or the like, has another function which is that of stabilizing the cylinder 10 in a horizontal position to prevent it from rolling on the floor or any other surface. To do this, the three-dimensional structure 3, 6a, 6b, 11a, 11b once completely unfolded and therefore in its attachment position may act as props for the cylinder 10 when it is lying down horizontally, as illustrated in FIG. 4.

Moreover, in an alternative form of embodiment, the three-dimensional structure 3, 6a, 6b, 11a, 11b is shaped to allow the filling connector 15 to be protected from dust, the weather, incorrect use, etc.

To this end, the opening or spacing 12 between the two arms 6a, 6b may be filled and form a protective cover that covers the filling connector 15 situated on the rear face 2b of the body 2 when the three-dimensional structure 3, 6a, 6b, 11a, 11b is in the rest position, namely is folded against the body 2 of the cap 1.

The invention is particularly well suited to use in the healthcare field for distributing a medical gas or gaseous mixture.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1. A protective cap for gas container equipped with a valve-assembly, comprising:
a cap body forming a protective shell delimiting an internal volume designed to accommodate all or part of the valve-assembly, and
an attachment device able to pivot between several angular positions, comprising:
a rest position in which the attachment device is fully folded, and
an attachment position in which the attachment device is completely deployed,
characterized in that the attachment device comprises a three-dimensional structure comprising two arms each bearing a cutout for fixing to a support, the three-dimensional structure comprising an interior face shaped to conform to the exterior profile of the body of the cap when the attachment device is in the rest position.

2. The cap of claim 1, wherein the attachment device is fixed pivotably about an axis AA situated on the rear face of the body of the cap.

3. The cap of claim 1, wherein the rear face and/or the lateral faces of the body of the cap are shaped to have an exterior profile that complements the interior face of the three-dimensional structure.

4. The cap of claim 1, wherein the rear face and/or the lateral faces of the body of the cap have at least one impression made in the external shell of the body, in which impression at least part of the three-dimensional structure is housed conforming to the exterior profile of the at least one impression.

5. The cap of the claim 4, wherein the three-dimensional structure comprises at least one curved interior face.

6. The cap of claim 5, wherein the attachment device pivots between the rest position and the attachment position through an angle (α) less than 180°, typically of between 90° and 170°.

7. The cap of claim 6, wherein the cap comprises at least one support upright secured to the cap body and bearing a carry handle.

8. The cap of claim 7, wherein the body of the cap and the three-dimensional structure are formed of polymer material.

9. The cap of claim 8, wherein the two arms are connected to one another by at least one connecting element.

10. The cap of claim 9, wherein the cap comprises a locking system allowing the attachment device to be locked and kept in the rest position.

11. A gas container equipped with a valve-assembly with or without inbuilt regulator, wherein the gas container comprises a protective cap of claim 1 arranged around at least part of the said valve-assembly.

12. The container of claim 11, wherein the container is a gas cylinder of a size of between 10 and 150 cm, and containing from 0.5 to 20 litres (water-equivalent capacity).
